(19) United States
(12) Patent Application Publication
(10) Pub. No.: US 2009/0076667 A1
(43) Pub. Date: Mar. 19, 2009

(54) SYSTEM, METHOD AND COMPUTER SOFTWARE CODE FOR DETERMINING A MISSION PLAN FOR A POWERED SYSTEM USING SIGNAL ASPECT INFORMATION

(76) Inventors: Tom Otsubo, Oak Grove, MO (US); Wolfgang Daum, Erie, PA (US); Craig Alan Stull, Kansas City, MO (US); Gregory Hann, Odessa, MO (US); Phillip Danner, Mukilteo, WA (US)

Correspondence Address: BEUSSE WOLTER SANKS MORA & MAIRE, P.A., 390 NORTH ORANGE AVENUE, SUITE 2500, ORLANDO, FL, 32801, US

(21) Appl. No.: 12/270,160

(22) Filed: Nov. 13, 2008

Related U.S. Application Data
(63) Continuation-in-part of application No. 11/765,443, filed on Jun. 19, 2007.
Application No. 11/765,443 is a continuation-in-part of application No. 11/669,364, filed on Jan. 31, 2007.
Application No. 11/669,364 is a continuation-in-part of application No. 11/385,354, filed on Mar. 20, 2006.
(60) Provisional application No. 60/988,191, filed on Nov. 15, 2007.
(60) Provisional application No. 60/894,039, filed on Mar. 9, 2007.
(60) Provisional application No. 60/939,852, filed on May 24, 2007.
(60) Provisional application No. 60/849,100, filed on Oct. 2, 2006.
(60) Provisional application No. 60/850,885, filed on Oct. 10, 2006.

(51) Int. Cl. G06F 19/00

(52) U.S. Cl. 701/2

(57) ABSTRACT

A mission planner system for a powered system, the mission planner system including a receiving device to collect aspect information as the powered system performs a mission, said aspect information being received from a remote location, a processor to determine a speed limit based at least in part on the aspect information, and a control system connected to the powered system to operate the powered system in response to the speed limit. A method and a computer software code for determining the mission plan with aspect information obtained from a remote location during the mission are also disclosed.

### CROSS-REFERENCE TO RELATED APPLICATIONS

This application claims the benefit of U.S. Provisional Application No. 60/988,191 filed Nov. 15, 2007, and claims priority to and is a Continuation-In-Part of U.S. application Ser. No. 11/765,443 filed Jun. 19, 2007, which claims priority to U.S. Provisional Application No. 60/894,039 filed Mar. 9, 2007, and U.S. Provisional Application No. 60/939,852 filed May 24, 2007, and incorporated herein by reference in its entirety.

U.S. application Ser. No. 11/765,443 claims priority to and is a Continuation-In-Part of U.S. application Ser. No. 11/669,364 filed Jan. 31, 2007, which claims priority to U.S. Provisional Application No. 60/849,100 filed Oct. 2, 2006, and U.S. Provisional Application No. 60/850,885 filed Oct. 10, 2006, and incorporated herein by reference in its entirety.

U.S. application Ser. No. 11/669,364 claims priority to and is a Continuation-In-Part of U.S. application Ser. No. 11/385,354 filed Mar. 20, 2006, and incorporated herein by reference in its entirety.

### BACKGROUND OF THE INVENTION

The field of invention relates to a powered system and, more specifically, to reducing fuel consumption and/or emission output of the powered system.

Powered systems, such as, but not limited to, off-highway vehicles, marine powered propulsion plants or marine vessels, rail vehicle systems or trains, agricultural vehicles, and transportation vehicles, usually are powered by a power unit, such as but not limited to a diesel engine. With respect to rail vehicle systems, the powered system is a locomotive, which may be part of a train that further includes a plurality of rail cars, such as freight cars. Usually more than one locomotive is provided as part of the train, where the grouping of locomotives is commonly referred to as a locomotive “consist.” Locomotives are complex systems with numerous subsystems, with each subsystem being interdependent on other subsystems.

An operator is usually aboard a locomotive to ensure the proper operation of the locomotive, and when there is a locomotive consist, the operator is usually aboard a lead locomotive. As noted above, a locomotive consist is a group of locomotives that operate together in operating a train. In addition to ensuring proper operations of the locomotive or locomotive consist, the operator is also responsible for determining operating speeds of the train and forces within the train. To perform these functions, the operator generally must have extensive experience with operating the locomotive and various trains over the specified terrain. This knowledge is needed to comply with prescribeable operating speeds that may vary with the train location along the track. Moreover, the operator is also responsible for assuring in-train forces remain within acceptable limits.

However, even with knowledge to assure safe operation, the operator cannot usually operate the locomotive so that the fuel consumption and emissions is minimized for each trip. For example, other factors that must be considered may include emission output, operator's environmental conditions like noise/vibration, a weighted combination of fuel consumption and emissions output, etc. This is difficult to do since, as an example, the size and loading of trains vary, locomotives and their fuel/emissions characteristics are different, and weather and traffic conditions vary.

Based on a particular train mission, when building a train, it is common practice to provide a range of locomotives in the train make-up to power the train, based in part on available locomotives with varied power and run trip mission history. This typically leads to a large variation of locomotive power available for an individual train. Additionally, for critical trains, such as Z-trains, backup power, typically backup locomotives, is typically provided to cover an event of equipment failure, and to ensure the train reaches its destination on time.

Furthermore, when building a train, locomotive emission outputs are usually determined by establishing a weighted average for total emission output based on the locomotives in the train while the train is in idle. These averages are expected to be below a certain emission output when the train is in idle. However, typically, there is no further determination made regarding the actual emission output while the train is in idle. Thus, though established calculation methods may suggest that the emission output is acceptable, in actuality, the locomotive may be emitting more emissions than calculated.

When operating a train, train operators typically call for the same notch settings when operating the train, which in turn may lead to a large variation in fuel consumption and/or emission output, such as, but not limited to, NOₓ, CO₂, etc., depending on a number of locomotives powering the train. Thus, the operator usually cannot operate the locomotives so that the fuel consumption is minimized and emission output is minimized for each trip since the size and loading of trains vary, and locomotives and their power availability may vary by model type.

Wayside signaling systems are used to communicate signal aspect information to a train as it travels along a railway route. Such transmitted information is further used in operating the train. One type of wayside signaling system features a continuous succession of DC train detection circuits along the entire length of the railway route through which to control a multiplicity of wayside signal devices spaced apart from each other along the route. Each train detection circuit covers a section of track and is electrically isolated from the next detection circuit via an insulated joint situated between each track section. Each train detection circuit merely detects whether its section of track is occupied by a train and communicates a signal indicative of the same to its corresponding wayside signal device. For this type of wayside signaling system, each wayside signal device typically takes the form of a display of colored lights or other indicia through which to visually communicate signal aspect information to a train operator. It is the signal aspect information that denotes the condition of the upcoming segment of track, e.g., whether it is clear, occupied by a train, or subject to some other speed restriction. Each signal aspect is conveyed by a color or combination of colors and denotes a particular course of action required by the operating authority. The particular colors of red, yellow, and green generally denote the same meaning as when used on a standard road traffic light. The signal aspect information is either viewed by the operator, or a video system captures the light signal and processes the information, which is then relayed to the operator.

Another type of wayside signaling system features a continuous succession of DC train detection circuits along the railway track route, which are used to control the wayside signal devices spaced along the route. Each of the wayside signal devices in this type of signaling system also includes an AC track circuit that accompanies or overlays each DC train detection circuit and serves to supplement its visual display. Through its AC track circuit, each wayside signal device communicates the signal aspect information over the rails as a cab signal. As a train rides on the rails, the cab signal is sensed by pick up coils mounted in front of the leading axle of the locomotive. The cab signal is filtered, decoded, and eventually conveyed to a cab signal device located in the cab of the locomotive. The cab signal device typically includes a display of colored lights to convey visually the signal aspect information so that the train operator will be kept apprised of the signal aspect applicable to the upcoming segment of track.

Another type of wayside signaling system features a continuous succession of DC train detection circuits along the railway track route, which are used to control the wayside signal devices spaced along the route. In this type of wayside signaling system, however, each of the wayside signal devices controls a track transponder located at a fixed point along the track before each wayside signal device. When a train is detected on a section of track, the train detection circuit corresponding thereto informs its corresponding wayside signal device. The train, however, can only receive the signal aspect information from the transponder as it passes by each fixed point. By using the track transponders to transmit additional encoded data, such as but not limited to the profile of the upcoming track segment and the signal block length, a train equipped with an automatic train protection system is able to enforce braking on routes covered by such a wayside signaling system.

A train owner usually owns a plurality of trains, wherein the trains operate over a network of railroad tracks. Because of the integration of multiple trains running concurrently within the network of railroad tracks, wherein scheduling issues must also be considered with respect to train operations, train owners would benefit from a way to optimize fuel efficiency and emission output so as to save on overall fuel consumption while minimizing emission output of multiple trains while meeting mission trip time constraints even as track information is provided via signal aspect information.

Wayside signaling devices that provide signal aspect information may also be used with other powered systems such as, but not limited to, off-highway vehicles, marine vessels, agricultural vehicles, transportation vehicles, etc. Similarly, owners and/or operators of such powered systems would appreciate the financial benefits realized when these powered systems produce optimize fuel efficiency and emission output so as to save on overall fuel consumption while minimizing emission output while meeting operating constraints, such as but not limited to mission time constraints, even as route information is provided via signal aspect information.

### BRIEF DESCRIPTION OF THE INVENTION

Embodiments of the present invention relate to a system, method, and a computer readable media for determining a mission plan for a powered system, using signal aspect information received from a remote location during the mission. (“Remote” refers to a location not on or in the powered system.) The system includes a receiving device to collect aspect information as the powered system performs a mission. The system also includes a processor to determine a speed limit based at least in part on the aspect information. A control system is connected to the powered system to operate the powered system in response to the speed limit (e.g., the determined speed limit received from the processor).

In another embodiment, the method includes receiving a speed limit or the signal aspect information from the remote location at the powered system. A speed limit is determined based at least in part on the signal aspect information. The mission plan (e.g., originally generated by the control system) is re-planned to comply with the speed limit and at least one other mission objective. The powered system is operated based on the re-planned mission plan.

In another embodiment, the computer software code is stored on a computer readable media and is executed with a processor. The computer software code includes a computer software module for determining a speed limit based at least in part on the signal aspect information received from the remote location, when executed with the processor. A computer software module for re-planning the mission plan to comply with the speed limit and at least one other mission objective, when executed with the processor, is also provided. The computer software code also includes a computer software module for operating the powered system based on the re-planned mission plan, when executed with the processor.

### BRIEF DESCRIPTION OF THE DRAWINGS

A more particular description of the invention briefly described above will be rendered by reference to specific embodiments thereof that are illustrated in the appended drawings. Understanding that these drawings depict only typical embodiments of the invention and are not therefore to be considered to be limiting of its scope, exemplary embodiments of the invention will be described and explained with additional specificity and detail through the use of the accompanying drawings in which:

FIG. 1 is a schematic diagram of a mission planner system for determining a mission plan for a powered system using signal aspect information, according to an embodiment of the present invention;

FIG. 2 is a schematic diagram of another embodiment of the mission planner system; and

FIG. 3 depicts a flowchart illustrating a method for determining a mission plan for a powered system using signal aspect information, according to an embodiment of the present invention.

### DETAILED DESCRIPTION OF THE INVENTION

Though exemplary embodiments of the present invention are described with respect to various powered systems, including rail vehicles, specifically trains and locomotives having diesel engines, exemplary embodiments of the invention are also applicable for other powered systems, such as but not limited to off-highway vehicles, marine vessels, agricultural and transportation vehicles, and stationary power units, each which may use a diesel or other engine. Towards this end, when discussing a specified mission, this includes a task or requirement to be performed by the powered system. Therefore, with respect to railway vehicle applications, marine vessel applications, off-highway vehicle applications, agricultural vehicle applications, and/or transportation vehicle applications, this may refer to the movement of the powered system from a present location to a destination.

Each powered system disclosed above may use at least one diesel engine or diesel internal combustion engine and may have a plurality of alternators. Even though diesel powered systems are disclosed, those skilled in the art will readily recognize that embodiments of the invention may also be utilized with non-diesel powered systems, such as but not limited to natural gas powered systems, bio-diesel powered systems, etc. Furthermore, as disclosed herein such non-diesel powered systems, as well as diesel powered systems, may include multiple engines, other power sources, and/or additional power sources, such as, but not limited to, battery sources, voltage sources (such as but not limited to capacitors), chemical sources, pressure based sources (such as but not limited to spring and/or hydraulic expansion), current sources (such as but not limited to inductors), inertial sources (such as but not limited to flywheel devices), gravitational-based power sources, and/or thermal-based power sources.

In one exemplary embodiment involving marine vessels, a plurality of tugs may be operating together where all are moving the same larger vessel, where each tug is linked in time to accomplish the mission of moving the larger vessel. In another exemplary embodiment a single marine vessel may have a plurality of engines. Off-highway vehicle (OHV) applications may involve a fleet of vehicles that have a same mission to move earth, from location “A” to location “B,” where each OHV is linked in time to accomplish the mission.

Exemplary embodiments of the invention solve the problems in the art by providing a system, method, and computer implemented method, such as a computer software code, for transmitting signal aspect information from a remote location to a powered system to control, such as through a mission optimization system, a characteristic of the powered system, such as but not limited to efficient fuel consumption and/or emission improvement. With respect to locomotives, exemplary embodiments of the present invention are also operable when the locomotive consist is in distributed power operations.

Persons skilled in the art will recognize that an apparatus, such as a data processing system, including a CPU, memory, I/O, program storage, a connecting bus, and other appropriate components, could be programmed or otherwise designed to facilitate the practice of the method of the invention. Such a system would include appropriate program means for executing the method of the invention.

Also, an article of manufacture, such as a pre-recorded disk or other similar computer program product, for use with a data processing system, could include a storage medium and program means recorded thereon for directing the data processing system to facilitate the practice of the method of the invention. Such apparatus and articles of manufacture also fall within the spirit and scope of the invention.

Broadly speaking, a technical effect is optimizing an operating characteristic, such as but not limited to fuel efficiency and/or emission output, by including signal aspect information to re-plan a mission during the actual mission of a powered system. To facilitate an understanding of the exemplary embodiments of the invention, it is described hereinafter with reference to specific implementations thereof. Exemplary embodiments of the invention may be described in the general context of computer-executable instructions, such as program modules, being executed by a computer. Generally, program modules, or computer software modules, include routines, programs, objects, components, data structures, etc. that perform particular tasks or implement particular abstract data types. For example, the software programs, or computer software code, that underlie exemplary embodiments of the invention can be coded in different languages, for use with different platforms. It will be appreciated, however, that the principles that underlie exemplary embodiments of the invention can be implemented with other types of computer software technologies as well.

Moreover, those skilled in the art will appreciate that exemplary embodiments of the invention may be practiced with other computer system configurations, including hand-held devices, multiprocessor systems, microprocessor-based or programmable consumer electronics, minicomputers, mainframe computers, and the like. Exemplary embodiments of the invention may also be practiced in distributed computing environments where tasks are performed by remote processing devices that are linked through a communications network. In a distributed computing environment, program modules may be located in both local and remote computer storage media including memory storage devices. These local and remote computing environments may be contained entirely within the locomotive, or adjacent locomotives in consist, or off-board in wayside or central offices where wireless communication is used.

Throughout this document the term “locomotive consist” is used. As used herein, a locomotive consist may be described as having one or more locomotives in succession, connected together so as to provide motoring and/or braking capability. The locomotives are connected together where no train cars are in between the locomotives. The train can have more than one locomotive consist in its composition. Specifically, there can be a lead consist and one or more remote consists, such as midway in the line of cars and another remote consist at the end of the train. Each locomotive consist may have a first locomotive and trail locomotive(s). Though a first locomotive is usually viewed as the lead locomotive, those skilled in the art will readily recognize that the first locomotive in a multi locomotive consist may be physically located in a physically trailing position. Though a locomotive consist is usually viewed as successive locomotives, those skilled in the art will readily recognize that a consist group of locomotives may also be recognized as a consist even when at least a car separates the locomotives, such as a tender car for storing an energy/fuel source, or such as when the locomotive consist is configured for distributed power operation, wherein throttle and braking commands are relayed from the lead locomotive to the remote trains by a radio link or physical cable. Towards this end, the term locomotive consist should be not be considered a limiting factor when discussing multiple locomotives within the same train.

A wayside signal or other device is also disclosed below. Even though the wayside device is disclosed specific to a rail vehicle system, the wayside device may be any device that is proximate a route that a powered system travels. For example, with respect to a marine vessel, the wayside device may be a buoy.

Referring now to the drawings, embodiments of the present invention will be described, consistent with the invention, examples of which are illustrated in the accompanying drawings. Wherever possible, the same reference numerals used throughout the drawings refer to the same or like parts. Exemplary embodiments of the invention can be implemented in numerous ways, including as a system (including a computer processing system), a method (including a computerized method), an apparatus, a computer readable medium, a computer program product, a graphical user interface, including a web portal, or a data structure tangibly fixed in a computer readable memory. Several embodiments of the invention are discussed below.

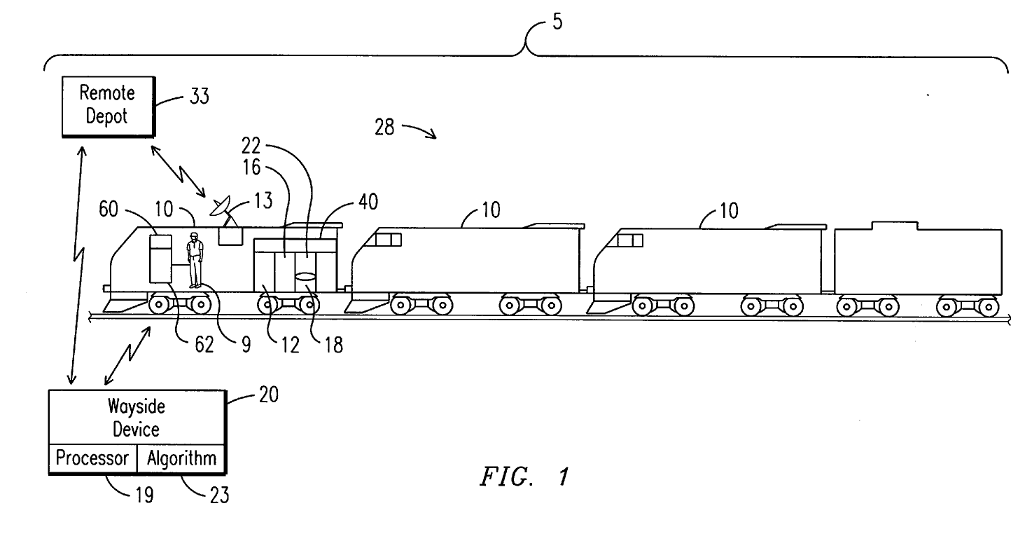

FIG. 1 depicts a diagram illustrating exemplary elements used for optimizing parameters with signal aspect information. More generally, FIG. 1 depicts a mission planner system for a powered system, which may carry out a process for optimizing at least one parameter associated with operations of the powered system during a mission. Though the diagram in FIG. 1 is specific to a rail vehicle system, as discussed above, the elements disclosed in FIG. 1 are applicable to other powered systems. With respect to the rail vehicle system, signal aspect information is provided to a train control system 12, such as but not limited to an incremental train control system (“ITCS”), located on a locomotive 10. A receiving device 13 (e.g., communication device) is provided on the locomotive 10 to receive the aspect information. For providing the signal aspect information, a wayside device 20 (such as but not limited to a vital wayside device) executes one or more logic operations installed as part of a control process on the wayside device. Those skilled in the art will readily recognize that the logic operations may be embodied in computer-readable instructions, such as an algorithm 23, that when executed by a processor 19 in the wayside device cause the processor 19 to quantify the aspect information (e.g., generate data containing information about the signal status of the wayside device) and transmit the aspect information for receipt by and use in operating the locomotive 10. For example, the parameters that identify specific aspect information to be used to operate the locomotive 10 are received by the receiving device and mapped to a database 18 on the train 5 that contains, but is not limited to, such information as the signal information and facing direction of the signal, i.e., traffic that the signal is controlling. Mapping or otherwise cross-referencing the aspect information to the database 18 identifies how to translate the aspect of a signal in a message that is transmitted from a wayside device 20 to the locomotive 10. A processor 16 is positioned on the train 5 to facilitate the mapping. The aspect information may be further assigned a specific speed limit within the database 18, such as but not limited to an aspect information-to-speed limit spreadsheet, which is in turn used to govern the speed of the locomotive 10.

Put another way, the database 18 includes a list or other data structure of various aspect information expected to be received from wayside devices 20. Correlated with each aspect information is a respective, designated speed limit. When aspect information is received by the receiving device 13, the processor 16 cross-references the received aspect information to the database 18 to determine the speed limit corresponding to the received aspect information. The control system 12 controls the locomotive/train in response to the determined speed limit, e.g., the locomotive/train is controlled so that the determined speed limit is not exceeded by the locomotive/train.

Based on the example above, the control system 12 includes the processor 16. Additionally, a memory storage device 22 is provided for storing the database 18. Though FIG. 1 illustrates the control system 12, processor 16, and memory storage device 22 as being either an integrated unit or located on a single locomotive 10, those skilled in the art will readily recognize that each of these systems may be independent units located on different locomotives but linked together, either through a wired or a wireless communication system. In either instance, the control system 12, processor 16, and receiving device 13 are at least functionally part of the mission planner system, which, as noted above, determines a mission plan for controlling a mission of the powered system.

When the locomotive 10 approaches the location of a signal, such as but not limited to the wayside device 20 that provides the signal, the signal aspect information is transmitted in a message from the wayside device 20 to the locomotive 10, where it is collected (e.g., received) by the receiving device 13. Though signal aspect information is primarily disclosed herein as originating from the wayside device 20, those skilled in the art will readily recognize that signal aspect information may originate from any device located along a route traveled by the locomotive. For example, a remote depot 33 may be an origin of the signal aspect information. Thus, in a broad sense, the aspect information is received by the receiving device from a remote location 20, 33, wherein by “remote” it is meant a location not on or in the train or other powered system.

The processor 16 extracts the aspect information from the message received from the wayside device 20. The message may be stored in the database 18 prior to or even after the aspect information is obtained. The corresponding speed associated with particular aspect information is then provided to enforce an allowable train speed. The corresponding speed may be displayed to an operator 9 aboard the train 5 to enforce the allowable train speed and/or provided to a trip optimization system 40 to enforce the allowable train speed.

This same speed limit that is associated with the signal aspect information can be used to determine the speed at which the locomotive should be traveling to optimize fuel consumption. In an exemplary embodiment, the speed limit associated with the aspect information may be greater than the current train speed. In this situation a fuel optimization algorithm, provided in the trip optimization system 40, may provide a new speed setting for increasing the train speed appropriately. As discussed above, application of the new speed setting may be accomplished manually or through the trip optimization system 40. An example of the trip optimization system 40 is disclosed in U.S. Application Publication No. 20070219680, dated Sep. 20, 2007, incorporated by reference herein in its entirety.

When the speed limit associated with the signal location is lower than the current train speed, sufficient brake pressure can be applied to reduce the train speed appropriately. As with increasing speed based on signal location, decreasing speed may be accomplished either manually and/or with the trip optimization system. Additionally, the trip optimization system 40 may further calculate a speed for the locomotive 10 which optimizes emission output or fuel consumption while satisfying the aspect information speed restriction and meeting other mission objectives. The trip optimization system 40 may be a device separate from the control system 12 or may be part of the control system 12.

FIG. 2 depicts another diagram illustrating exemplary elements used for optimizing at least one parameter associated with operation of a powered system using signal aspect information, according to an embodiment of the present invention. As illustrated, the processor 16, algorithm 17, and database 18 are located at the wayside device 20 instead of on the train. In this embodiment, processing to determine a speed limit is performed at the wayside device 20 and the speed limit information is transmitted to the locomotive 10 where it is provided directly to the control system 12 for inclusion in re-planning the mission plan. In this embodiment, all determinations, or calculations, are made at the wayside device.

As disclosed above with respect to FIG. 1, signal aspect information provides information about a forthcoming track segment where the information is not specific to a train 5. With respect to a locomotive consist 28, the control system 12 may include an algorithm (or, more specifically, computer-readable instructions) that when executed by the processor 16 causes the processor 16 to determine speed settings for each locomotive 10 in the locomotive consist 28 based on the signal aspect information received. In another exemplary embodiment, the received signal aspect information may include information specific to a plurality of locomotive consists 28. In this example, the control system 12 has an algorithm, or more specifically computer-readable instructions, that when executed by the processor 16 causes the processor to evaluate the information received, and based on locomotive consist information specific to the train 5, to select speed settings for each locomotive 10 based on the signal aspect information.

A plurality of communication techniques may be used for transmitting signal aspect information to the mission planner system. Such techniques may include, but are not limited to, in combination or individually, an axle counter information transmitted from the wayside device 20 or from another remote location (such as but not limited to a remote depot 33) to the receiving device 13, and/or baseline information, or another track-installed cab signaling device where information is transmitted from the wayside device 20 or from the remote depot 33 to the receiving device 13. The remote depot 33 may have a control system that communicates directly to the train 5, or through a wayside device 20 to the train 5.

In another embodiment the communication system uses signal light information transmitted directly to the locomotive. Other methods of transmission may include, but are not limited to, satellite transmission, millimeter wave transmission, Global System for Mobile communications (“GSM”) and Code Division Multiple Access (“CDMA”) or other cellular network-based communications, visual indications directly to the train driver or operator 9, acoustic transmission either over the air or through the rails, signal light transmissions directly to the locomotive 10 where the light is modulated to indicate the aspect, vehicle-to-vehicle transmissions relaying aspect information from trains on the same track or from trains on adjacent tracks, vibration (i.e., sound energy transmitted either over the air or through the rails), electromagnetic energy either pulsed or constant that can be transmitted from a wayside device 20 or trains 30, and/or heat signature on the track and using the rate of decay of the heat to determine potential aspect information from trains on the same track and trains using adjacent tracks.

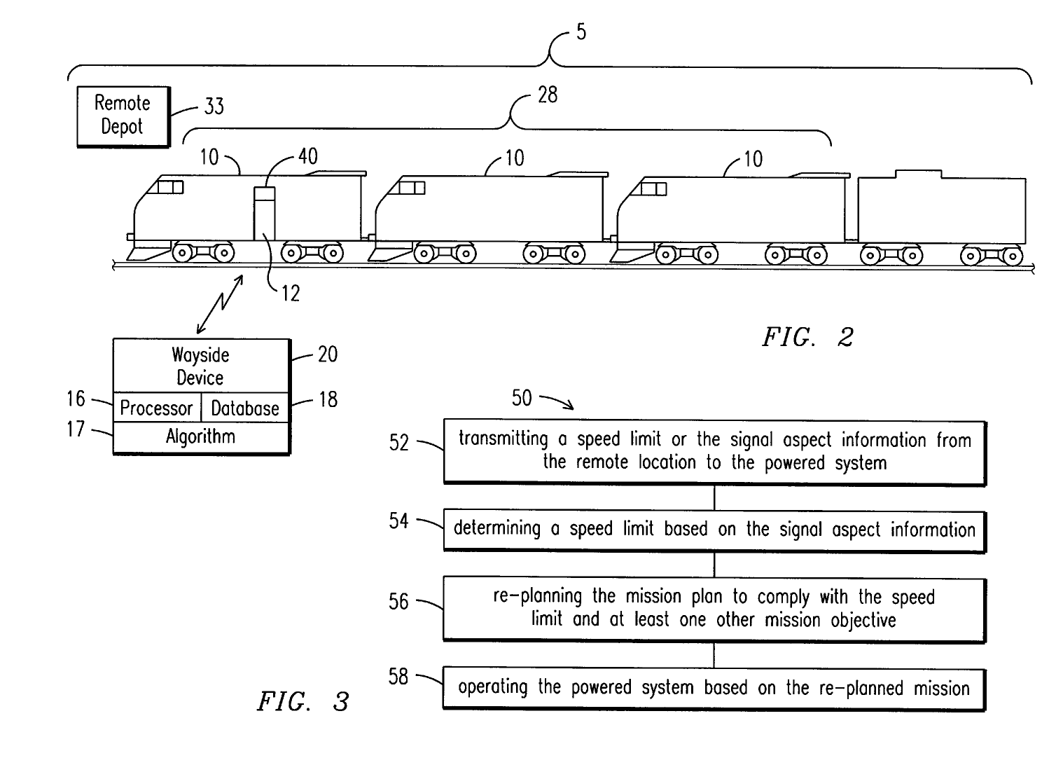

FIG. 3 depicts a flowchart illustrating a method for determining a mission plan for a powered system, using signal aspect information, and which may include optimizing at least one parameter associated with operation of the powered system during the mission, according to an embodiment of the present invention. As disclosed above, the speed limit may be determined from the signal aspect information at the remote location, e.g., the wayside device 20 or remote depot 33, or aboard the locomotive. Therefore, the flowchart 50 illustrates transmitting a speed limit or the signal aspect information from the remote location to the powered system, at 52. The speed limit is determined based at least in part on the signal aspect information, at 54. (That is, the speed limit is determined based on the signal aspect information, but may also be based on other factors, such as time of day or date and weather conditions.) The mission plan is re-planned to comply with the speed limit and at least one other mission objective, such as but not limited to mission duration, mission duration for a certain segment, other speed requirements, fuel use, etc., at 56. The powered system is operated based on the re-planned mission, at 58. Transmitting signal aspect information, at 52, determining the speed limit, at 54, re-planning the mission, at 56, and operating the powered system, at 58 may be performed in a closed-loop process, or using a closed-loop technique.

When implemented through the closed-loop process, and as further illustrated in FIG. 1, a notification system 60, such as a display, is provided to allow the operator 9 to witness changes associated with re-planning. Those skilled in the art will readily recognize the notification system may incorporate a plurality of techniques to notify the operator when the speed has changed in response to a change of speed limits. Such techniques may include visual, touch, sound, and/or smell. A control device 62 is available to the operator 9 to allow the operator 9 to take control of the train 5, if the operator 9 would prefer to operate the train 5 manually. As disclosed above, the method illustrated in FIG. 3 may be performed with a computer software code having computer software modules. The computer software code is stored on a computer readable media and is operable with a processor, where the processor is specifically designed to perform the functions disclosed herein.

An embodiment of the present invention relates to a computer software code stored on a computer readable media. The computer software code is configured for execution with a processor 16 designated for determining a mission plan for a powered system using aspect information obtained from a remote location during a mission. The computer software code comprises a computer software module for determining a speed limit based on the signal aspect information received from the remote location, when executed with the processor. The computer software code also comprises a computer software module for re-planning the mission plan to comply with the speed limit and at least one other mission objective, when executed with the processor. The computer software code also comprises a computer software module for operating the powered system based on the re-planned mission plan, when executed with the processor.

In another embodiment, the re-planned mission plan is optimized in regards to at least one parameter associated with operation of the powered system during the mission.

While the invention has been described herein with reference to various exemplary embodiments, it will be understood by those skilled in the art that various changes, omissions and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims. Moreover, unless specifically stated any use of the terms first, second, etc., do not denote any order or importance, but rather the terms first, second, etc., are used to distinguish one element from another.

What is claimed is:

1. A mission planner system for a powered system, the mission planner system comprising:
a receiving device to collect aspect information as the powered system performs a mission, said aspect information being received from a remote location;
a processor to determine a speed limit based at least in part on the aspect information; and
a control system connected to the powered system to operate the powered system in response to the speed limit.

2. The system according to claim 1, wherein:
the control system is configured to generate a mission plan for controlling the mission of the powered system; and
the mission plan is re-planned when the speed limit is determined, based at least in part on the aspect information received by the receiving device.

3. The system according to claim 1, wherein operating the powered system in response to the speed limit comprises operating the powered system so that the speed limit is not violated, and where emissions output or fuel consumption is reduced while at least one mission requirement other than the speed limit is not violated.

4. The system according to claim 1, further comprising a data storage device connected to the processor and/or control system and configured to store a database used to determine a speed limit associated with the aspect information and/or to store aspect information.

5. The system according to claim 1, further comprising computer readable instructions that when executed by the processor cause the processor to quantify the aspect information and provide the speed limit associated with the aspect information.

6. The system according to claim 1, wherein the powered system comprises a railway system, a marine vessel, an off-highway vehicle, a transportation vehicle, and/or an agricultural vehicle.

7. The system according to claim 1, wherein the control system operates in a closed loop process.

8. The system according to claim 1, further comprising a manual controller which an operator may use to control the powered system.

9. The system according to claim 1, further comprising a notification system configured to notify an operator when a speed of the powered system is changed in response to the speed limit.

10. A method for determining a mission plan for a powered system, the method comprising:
receiving, at the powered system, a speed limit or signal aspect information from a remote location;
determining the speed limit based at least in part on the signal aspect information;
re-planning the mission plan to comply with the speed limit and at least one other mission objective; and
operating the powered system based on the re-planned mission plan.

11. The method according to claim 10, wherein determining the speed limit further comprises evaluating the aspect information by cross-referencing the aspect information to a database that correlates respective aspect information to respective speed limits.

12. The method according to claim 10, wherein receiving the signal aspect information, determining the speed limit, re-planning the mission plan, and operating the powered system are performed in a closed-loop process.

13. The method according to claim 10, wherein the powered system comprises a railway system, a marine vessel, an off-highway vehicle, a transportation vehicle, and/or an agricultural vehicle.

14. The method according to claim 10, wherein the re-planned mission plan is optimized in regards to at least one parameter associated with operation of the powered system during the mission.

15. A computer software code stored on a computer readable media and configured for execution with a processor designated for determining a mission plan for a powered system using aspect information obtained from a remote location during a mission, the computer software code comprising:
a computer software module for determining a speed limit based on the signal aspect information received from the remote location, when executed with the processor;
a computer software module for re-planning the mission plan to comply with the speed limit and at least one other mission objective, when executed with the processor; and
a computer software module for operating the powered system based on the re-planned mission plan, when executed with the processor.

16. The computer software code according to claim 15, wherein the powered system comprises a railway system, a marine vessel, an off-highway vehicle, a transportation vehicle, and/or an agricultural vehicle.

17. The computer software code of claim 14, wherein the re-planned mission plan is optimized in regards to at least one parameter associated with operation of the powered system during the mission.
